(19) United States
(12) Patent Application Publication
(10) Pub. No.: US 2007/0052536 A1
(43) Pub. Date: Mar. 8, 2007

(54) Subliminal audio burglar deterrent

(76) Inventors: Gary J. Hawkes, London (GB); Stuart G. Hawkes, Amersham (GB)

Correspondence Address: GREENBERG TRAURIG, LLP, 77 WEST WACKER DRIVE, SUITE 2500, CHICAGO, IL, 60601-1732, US

(21) Appl. No.: 10/578,343

(22) PCT Filed: Nov. 8, 2004
(86) PCT No.: PCT/GB04/04697

§ 371 Date: May 5, 2006

(30) Foreign Application Priority Data
Nov. 6, 2003 (GB) 0325947.0

(51) Int. Cl. G08B 21/00

(52) U.S. Cl. 340/540

(57) ABSTRACT

The present invention is directed to a subliminal audio burglar deterrent device IP and system wherein a subliminal message is created and broadcast using techniques to unconsciously cause a burglar to mistakenly perceive the presence of a human or an animal in the space being protected.

### BACKGROUND OF THE DISCLOSURE

1. Field of the Invention

The present invention relates in general to a system and method for providing subliminal auditory signals to people so as to unconsciously deceive the listener's perception of reality, and thus modify the listener's behavior. More specifically, the present invention relates to subliminal auditory signals below a would-be house burglar's conscious recognition as a means to dissuade such persons from actually carrying out their intent to burglarize a particular home employing the invention.

2. Background Art

Subliminal messages effecting the unconscious mind are well known in the art. For example, U.S. Pat. No. 4,395,600 issued to Lundy et al. discloses the use of subliminal auditory signals to provide anti-shoplifting messages below the conscious recognition of would-be shoplifters so as to deter such persons from actually carrying out their crime. However, the prior art does not address the techniques employed to create the subliminal message itself. Indeed, Lundy et al. merely discloses a means for continuously adjusting the amplitude of the subliminal message signal to insure that the message remains below the threshold of conscious awareness.

Accordingly, it would be desirable to provide a system and a device for causing a burglar to unconsciously perceive the simulated presence of at least one person or animal in a home or office so as to dissuade that burglar from committing their crime.

These and other desirable characteristics of the present invention will become apparent in view of the present specification, including claims, and drawings.

### SUMMARY OF THE INVENTION

The present Invention comprises, in part, a subliminal audio burglar deterrent system comprising a playback system operable to broadcast audible sounds and media operably compatible with the playback system. The playback system preferably includes at least one loudspeaker, a signal amplifier, and a signal source. The media preferably includes at least one prerecorded dynamic audio signal, not consciously perceivable, operably configured to simulate the presence of at least one person or animal in a space being protected. The at least one prerecorded dynamic audio signal is, in a preferred embodiment, capable of reproduction with maximum realism on a conventional sound reproduction system, which may be hidden or unobtrusive, the signal being recorded utilizing primarily midrange and high audible frequencies with no compression of the at least one audio signal for maximum realism, and further being monaurally recorded for optimum concentration of sound dispersal, and being capable of endless playback with no perceived periods of silence greater than 10 seconds in length. In addition, the at least one prerecorded dynamic audio signal is preferably recorded at a recording level that is relatively high as compared to the ambient background noise. Application of the subliminal audio burglar deterrent system has a subliminal effect on a listener so as to dissuade the listener from committing a burglary in the space being protected.

The present invention also comprises, in part, a subliminal audio burglar deterrent device comprising at least one prerecorded dynamic audio signal, not consciously perceivable, operably configured to simulate the presence of at least one person or animal In a space being protected. The preferred at least one audio signal is chosen on the basis that it can only be made by people or animals in attendance and not by machinery left to run unattended. The at least one prerecorded dynamic audio signal is preferably capable of reproduction with maximum realism on a conventional sound reproduction system, which may be hidden or at least unobtrusive, the signal being recorded utilizing primarily midrange and high audible frequencies with no compression of the at least one audio signal for maximum realism. The signal Is preferably monaurally recorded for optimum concentration of sound dispersal, and being capable of endless playback with no perceived periods of silence greater than 10 seconds in length. Furthermore, the at least one prerecorded dynamic audio signal is recorded at a recording level that is relatively high as compared to the ambient background noise. Application of the subliminal audio burglar deterrent device has a subliminal effect on a listener so as to dissuade the listener from committing a burglary in the space being protected. The media may also include recorded content that is consciously perceivable by an intruder that likewise contains threatening or deterrent messages.

### BRIEF DESCRIPTION OF THE DRAWINGS

FIG. 1 shows a diagram illustrating some of the various audio sources used to produce the subliminal audio burglar deterrent according to the present invention.

### DETAILED DESCRIPTION OF THE INVENTION

While this invention is susceptible of embodiment in many different forms, there is shown In the drawings and will herein be described in detail, a preferred embodiment with the understanding that the present disclosure should be considered as an exemplification of the principles of the invention and is not intended to limit the invention to the embodiment so illustrated.

A preferred embodiment of the subliminal audio burglar deterrent system includes a playback system having common audio components such as loudspeakers, amplifier, and a signal source (i.e. a hard drive, a compact disk (CD) player, digital video/versatile disk (DVD), AM/FM tuner, etc.) providing line signal output to the amplifier. The signal source in a preferred embodiment comprises a compact disk player capable of playing at least one compact disk containing pre-recorded audible sounds. The sound system preferably is a conventional sound reproduction system. The equipment may be small, hidden or at least unobtrusively placed, so as to enhance the effect that the sounds are indeed ambient, and not from a particular, artificial, source.

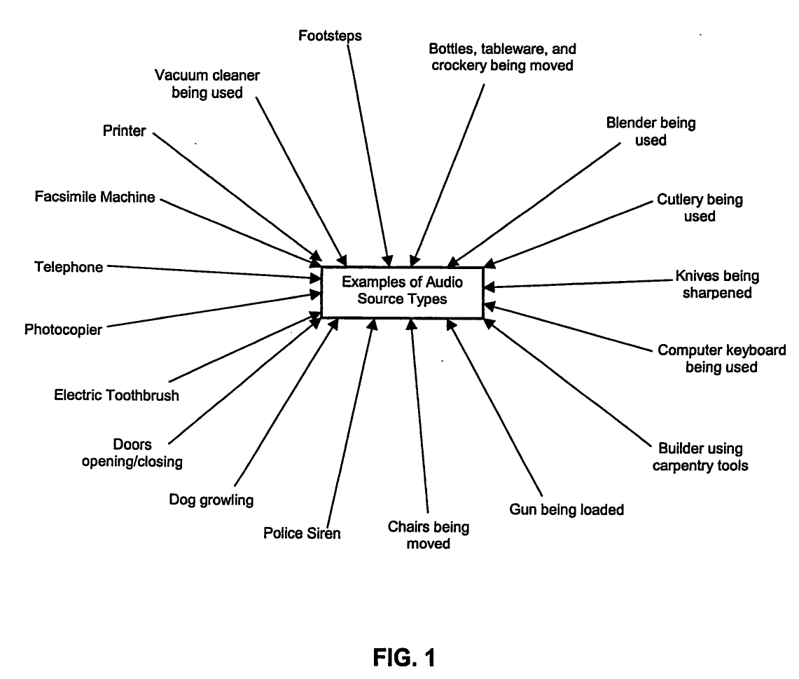

In a preferred embodiment, the compact disk contains recordings of various household and/or office noises, including sounds selected from such common, everyday sounds such as a vacuum cleaner being used, a blender being used, footsteps, doors opening and closing, cutlery being used, a dog growling or barking, chairs being moved, keyboards being used, fax machines and telephones in use, photocopiers being used, knives being sharpened, printers being used, bottles being moved, tableware and crockery being used, electric tooth brush being used, two or more people talking, and builders using common carpentry tools, among others. An examination of FIG. 1 illustrates some of the many household and office noises that might be recorded and placed onto a compact disk or other media compatible with the signal source.

In a preferred embodiment, the household or office noises that are actually recorded are chosen on the basis that they can only be made by people or animals in attendance and not by machinery left to run unattended. In addition, these noises are also dynamic sounds which reproduce effectively on small (“modest”) sound systems, utilizing midrange and high audible frequencies (i.e. frequencies typically above 300 Hz up to approximately 20,000 Hz), recorded without any electronic compression, for maximum realism upon playback.

In a preferred embodiment of the present invention, the compact disk player and/or the compact disk itself is configured to play the prerecorded household or office noises endlessly so as to never exceed a 10 second period of silence. Preferably, the length of the recording of uninterrupted, non-repeating content will be sufficiently great that under normal circumstances, an intruder will be prompted to leave the premises, long before the recording repeats itself. A modern compact disk has a maximum recording length of about 70 minutes. Presumably, upon exposure to the deterrent messages, an intruder would be prompted to leave the premises long before such a period lapses.

The present invention works by subliminally confusing a would-be burglar into believing that the house or office is actually occupied by a human or animal, by means of the audible broadcast of the prerecorded sounds, so as to dissuade the burglar from carrying out their crime. The subliminal effect is achieved by masking the prerecorded household or office noises with natural ambient, environmental sounds in a rhythm that engages the burglar's mind unconsciously so as to create fear beyond the apprehension caused by the cognitive recognition of danger associated with the simulated presence of a human or animal. The masking is accomplished by recording the household and office noises so as to have an signal amplitude higher than that of the ambient background noise. In addition, layered within these recordings are ambient environment noise such as dogs growling or barking, a police siren blaring in the distance, a gun being loaded, etc. The recordings are also made in monaural mode so as to maximize the concentration of sound dispersal. The prerecorded household and office noises in the preferred embodiment of the present invention would be capable of being broadcast on a conventional sound reproduction equipment, which may be hidden or at least unobtrusive, so as to maximize the confusion and perception errors in the burglar's mind. Preferably, the sounds will be selected so as to not only subconsciously prompt the intruder to abstain from criminal or harmful behavior, but also to be prompted to leave the premises quickly.

In alternative preferred embodiments of the invention, the recording, in addition to bearing subliminal or otherwise not fully consciously audible messages, the recording content may also include overtly, consciously audible messages of a deterrent nature. This may produce an even greater impact upon the intruder, in that the feelings of dread or discomfort may be perceived as being greater than can be legitimately attributable to the overt, consciously perceived sounds, and thus confusing to the intruder, leading to enhanced feelings of insecurity, and hopefully, greater prompting to depart the premises.

The foregoing descriptions and drawing merely explain and illustrate the invention and the invention is not to be limited thereto.

What is claimed is:

1. A subliminal audio burglar deterrent system, comprising:
a playback system operable to broadcast audible sounds, the playback system including at least one loudspeaker, a signal amplifier, and a signal source;
media operably compatible with the playback system;
wherein the media includes at least one prerecorded dynamic audio signal, not consciously perceivable, operably configured to simulate the presence of at least one person or animal in a space being protected;
wherein the at least one prerecorded dynamic audio signal further includes
being capable of reproduction with maximum realism on a conventional sound reproduction system, which may be hidden or at least unobtrusive,
being recorded utilizing primarily midrange and high audible frequencies with no compression of the at least one audio signal for maximum realism,
being monaurally recorded for optimum concentration of sound dispersal,
being capable of endless playback with no perceived periods of silence greater than 10 seconds in length;
wherein the at least one prerecorded dynamic audio signal is recorded at a recording level that is relatively high as compared to the ambient background noise; and
wherein application of the subliminal audio burglar deterrent system has a subliminal effect on a listener so as to dissuade the listener from committing a burglary in the space being protected.

2. The invention according to claim 1 wherein the media is a compact disk (CD).

3. The invention according to claim 1 wherein the subliminal effect is achieved by recording the at least one prerecorded dynamic audio signal in a rhythm so as to engage the listener's mind unconsciously so as to create fear and trepidation.

4. The invention according to claim 1 wherein the subliminal effect is achieved by playback of at least one man's voice having a deep and serious tone.

5. The invention according to claim 1 wherein the at least one prerecorded dynamic audio signal contains recordings of household noises.

6. The invention according to claim 5 wherein the household noises comprise at least one of the following: sounds of a vacuum cleaner; sounds of a blender, sounds of at least one person's footsteps; sounds of at least one door opening and closing; sounds of cutlery being used; sounds of at least one chair being moved; sounds of a computer keyboard being used; sounds of a facsimile machine in use; sounds of a telephone being used; sounds of a knife being sharpened; sounds of at least one dog growling, barking, chirping, or howling; sounds of a printer in use; sounds crockery being moved; sounds of an electric toothbrush being used; sounds of at least one carpentry tool being used.

7-20. (canceled)

21. The invention according to claim 1 wherein the at least one prerecorded dynamic audio signal contains recordings of workplace noises.

22. The invention according to claim 21 wherein the workplace noises comprise at least one of the following: sounds of at least one person's footsteps; sounds of at least one door opening and closing; sounds of at least one chair being moved; sounds of a computer keyboard being used; sounds of a facsimile machine in use; sounds of a telephone being used; sounds of a photocopier being used.

23-28. (canceled)

29. A subliminal audio burglar deterrent device, comprising:
at least one prerecorded dynamic audio signal, not consciously perceivable, operably configured to simulate the presence of at least one person or animal in a space being protected, the at least one audio signal being chosen on the basis that it can only be made by people or animals in attendance and not by machinery left to run unattended;
the at least one prerecorded dynamic audio signal further including
being capable of reproduction with maximum realism on a conventional sound reproduction system, which may be hidden or at least unobtrusive,
being recorded utilizing primarily midrange and high audible frequencies with no compression of the at least one audio signal for maximum realism,
being monaurally recorded for optimum concentration of sound dispersal, being capable of endless playback with no perceived periods of silence greater than 10 seconds in length;
wherein the at least one prerecorded dynamic audio signal is recorded at a recording level that is relatively high as compared to the ambient background noise; and
wherein application of the subliminal audio burglar deterrent device has a subliminal effect on a listener so as to dissuade the listener from committing a burglary in the space being protected.

30. The invention according to claim 29 wherein the subliminal effect is achieved by recording the at least one prerecorded dynamic audio signal in a rhythm so as to engage the listener's mind unconsciously so as to create fear and trepidation.

31. The invention according to claim 29 wherein the subliminal effect is achieved by playback of at least one man's voice having a deep and serious tone.

32. The invention according to claim 29 wherein the at least one prerecorded dynamic audio signal contains recordings of household noises.

33. The invention according to claim 32 wherein the household noises comprise at least one of the following: sounds of a vacuum cleaner; sounds of a blender; sounds of at least one person's footsteps; sounds of at least one door opening and closing; sounds of cutlery being used; sounds of at least one chair being moved; sounds of a computer keyboard being used; sounds of a facsimile machine in use; sounds of a telephone being used; sounds of a knife being sharpened; sounds of at least one dog growling, barking, chirping, or howling; sounds of a printer in use; sounds of crockery being moved; sounds of an electric toothbrush being used; sounds of at least carpentry tool being used.

34-47. (canceled)

48. The invention according to claim 29 wherein the at least one prerecorded dynamic audio signal contains recordings of workplace noises.

49. The invention according to claim 48 wherein the workplace noises comprise at least one of the following: sounds of at least one person's footsteps; sounds of at least one door opening and closing; sounds of at least one chair being moved; sounds of a computer keyboard being used; sounds of a facsimile machine in use; sounds of a telephone being used; sounds of a photocopier being used.

50-55. (canceled)

56. The invention according to claim 1, wherein the media also includes at least one prerecorded audio signal that is consciously perceivable by a listener.

57. The invention according to claim 56, wherein the at least one consciously perceivable prerecorded audio signal contains content that is deterrent in nature to an intruder.

58. The invention according to claim 29, wherein the media also includes at least one prerecorded audio signal that is consciously perceivable by a listener.

59. The invention according to claim 58, wherein the at least one consciously perceivable prerecorded audio signal contains content that is deterrent in nature to an intruder.
